(19) United States
(12) Patent Application Publication
(10) Pub. No.: US 2009/0067005 A1
(43) Pub. Date: Mar. 12, 2009

(54) Methods For Smart Copying With Improved Scanning Efficiency

(76) Inventors: Mahesan Chelvayohan, Lexington, KY (US); Ronald Todd Sellers, Stamping Ground, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/850,958

(22) Filed: Sep. 6, 2007

(51) Int. Cl. H04N 1/04

(52) U.S. Cl. 358/2.1; 358/486

(57) ABSTRACT

A method for scanning a document and printing a copy with improved efficiency is provided. The method includes scanning the document with a first resolution, determining a content type of the scanned document while scanning at the first resolution and determining an optimum scanning resolution based on the content type. Rescanning the document at the optimum resolution if the first resolution does not correlate with the optimum resolution, selecting a print setting based on the content type and printing the copy using the print setting.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to scanners and printers, and more particularly to an improved method of scanning documents to determine the optimum scanning resolution and print settings.

2. Description of the Related Art

Today's scanners have the ability to copy a variety of documents with one scanner. However, documents can vary in content from black and white text to full color pictures. Traditionally, three qualities are of particular importance when scanning and printing a document: (1) whether the document is black/white, grayscale or color; (2) whether the document has a large or small color gamut; and (3) whether the document is text or photo or a mixture of both. Depending on the properties of the documents, and the desired print quality, different scanning and print settings may be preferred. For example, a document with a large color gamut has a wider spectrum of colors than a document with a small color gamut. As appreciated in the art, the preferred print metrics (color tables, shingles modes, resolutions, etc.) for the large color gamut document will therefore differ from the print metrics for the small color gamut document.

As a result of diverse content, a current method to improve quality in copied documents is the use of “smart” copying. Smart copying fully pre-scans the document at a relatively reduced resolution to determine its content type and color qualities. After the content is identified, the document is rescanned at the optimal resolution and printed using the preferred print settings. This method is notably incorporated into combined scanners/printers often referred to as “all-in-ones.”

While smart copying improves the quality of copies by establishing optimum scan and print parameters on an individual basis, the full pre-scan costs additional time for the user. Each document is scanned twice; once for the full pre-scan and once for the full final scan. As such, there is a need for a more efficient method of determining the content type of documents. Accordingly, improved methods of scanning are desired.

### SPECIFICATION

The present invention relates to new and improved methods for scanning documents and printing copies using more efficient scanning techniques to determine the optimal scanning resolution and print settings.

One aspect of the present invention is to provide a method for scanning a document and printing a copy. The method comprises scanning the document with a first resolution, determining a content type of the scanned document while scanning at the first resolution and determining an optimum scanning resolution based on the content type. The method further comprises rescanning the document at the optimum resolution if the first resolution does not correlate with the optimum resolution, selecting a print setting based on the content type and printing the copy using the print setting.

Another aspect of the present invention is to provide a computer readable medium having a computer program embodied thereon, the computer program being executable by a machine to scan a document and print a copy. The machine executes the acts of scanning the document with a first resolution, determining a content type of the scanned document while scanning at the first resolution and determining an optimum scanning resolution based on the content type. The machine further executes the acts of rescanning the document at the optimum resolution if the first resolution does not correlate with the optimum resolution, selecting a print setting based on the content type and printing the copy using the print setting.

Another aspect of the present invention is to provide an all-in-one printer for scanning a document and printing a copy. The all-in-one printer comprises a scanner adapted to scan a portion of the document at a first resolution. The scanner is further adapted to determine a content type of the document based on the scanned portion of the document, determine an optimum scanning resolution based on the content type and create an image by either continuing scanning of a remainder of the document if the first resolution is similar to the optimum resolution, or, rescanning the document with the optimum resolution if the first resolution is not similar to the optimum resolution. The all-in-one printer further comprising a memory adapted to temporarily store the image and a printer adapted to print a copy of the image using a print setting based on the content type.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a top view of a scanner incorporating the present invention; and

FIG. 2 is a diagram of the method of an exemplary embodiment of improved smart scanning.

The embodiments set forth in the drawing are illustrative in nature and not intended to be limiting of the invention defined by the claims. Moreover, the individual features of the drawings and the invention will be more fully apparent and understood in view of the detailed description.

### DETAILED DESCRIPTION

It is to be understood that the invention is not limited in its application to the details of construction and the arrangement of components set forth in the following description or illustrated in the figure. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware.

However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

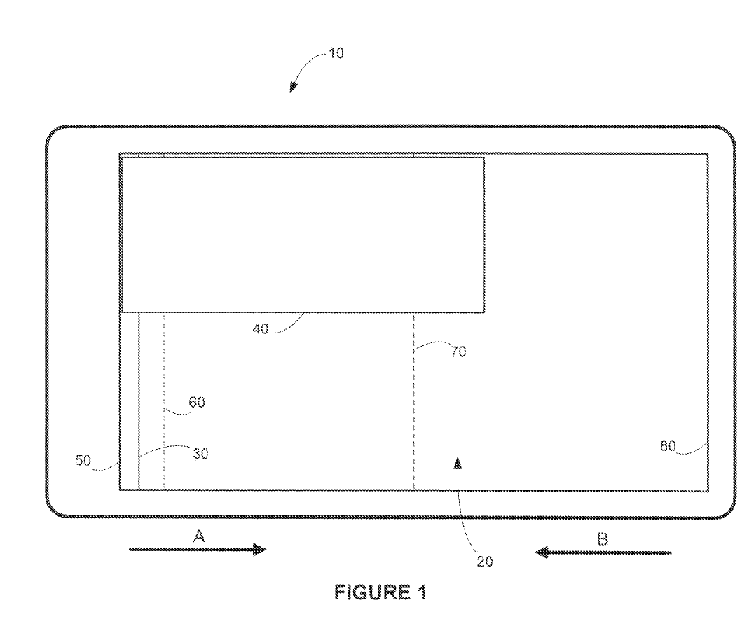

FIG. 1 illustrates an overhead view of a scanner. The scanner 10 includes a scanner area 20 and a scanning bar 30. A document 40 to be scanned is selected by the user. The document can vary in properties from a simple black and white text document to a full color-picture. The document 40 is placed on the scanning area 20 so that the scanning bar 30 can move across the scanning area 20 to scan the document 40. The scanning bar 30 initiates from a first end of the scanner 50. The scanning bar 30 then progresses in a first direction A from the first end of the scanner 50 to the second end of the scanner 80. After completing its first pass, the scanning bar 30 returns to the first side of the scanner 50 in a second direction B. A copy of the document is then printed from a printer. The printer can either be a part of the scanner, commonly referred to as an all-in-one, or separate from the scanner.

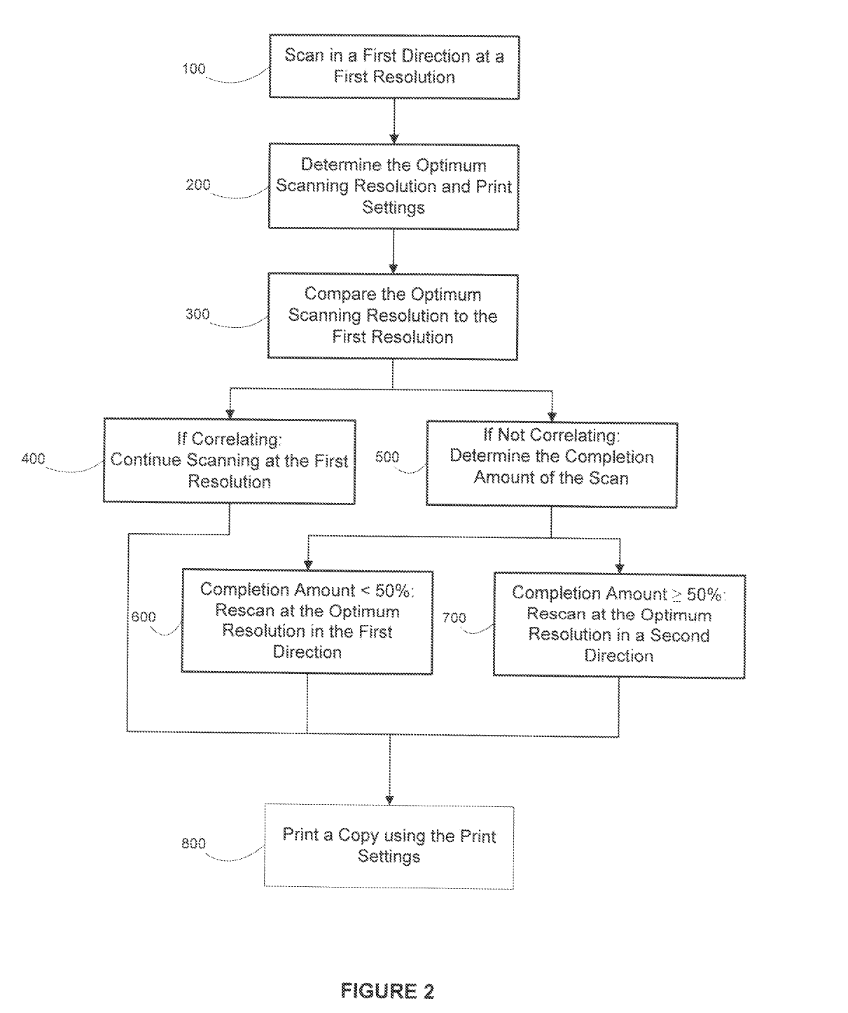

One exemplary method of the present invention is illustrated in FIG. 2. The document is scanned in a first direction at a first resolution 100. The first resolution is typically a low or nominal resolution to increase the scanning speed and decrease time. A nominal resolution is typically a resolution between a low resolution, which may be used for basic black and white documents, and a high resolution, which may be preferred for photos with a large color gamut. For today's scanners, a nominal resolution is typically around 300 dpi (dot per inch) and a high resolution is typically around 600 dpi. As appreciated in the art, the specific resolutions referred to as low, nominal and high may change as improvements are made to scanner and printer technology. Additionally, those skilled in the art appreciate that resolution may be defined in various terms and still embody the spirit of the invention. Such resolution terms include, but are not limited to, pixels per inch, dots per inch and samples per inch.

The optimum scanning resolution and print settings are determined from the first scan 200. The optimum scanning resolution and print settings depend on the content of the document and the user's input. For example, whether the document is black and white, grayscale or color and whether the color gamut is large or small may influence the optimum scanning resolution and print settings. Furthermore, a user may request a high quality copy or low quality copy that may effect the optimum resolution or print settings. Depending on the specific scanner and printer, other properties may also be determined and incorporated into the optimum scanning resolution and print settings.

One exemplary embodiment of the present invention, illustrated in FIG. 1, limits the act of scanning at a first resolution to travel only a limited portion 60 of the scanning area 20, before the optimum scanning resolution and print settings are determined. Today's scanners can often determine document properties with only a limited section of a document. For example, a scanner can quickly identify the color gamut present in a picture, as compared to a black and white document, without traversing the document's entire length. Therefore, the portion of the document to be initially scanned may be very small and still embody the spirit of the invention. Predetermined initial scanning lengths can range from a small portion of the document to a large portion of the document and still be effective at determining the content type.

In reference to FIG. 2, the optimum scanning resolution is then compared to the first scanning resolution 300. If the first scanning resolution correlates to the optimum resolution, then the scan continues in the first direction at the first resolution 400. Some variation between the first resolution and the optimum resolution may still be considered as correlating. For example, a range of resolutions that are considered correlating may be set on the scanner during manufacturing. In the alternative, a user may specify the range of resolutions acceptable to be considered as correlating. In the latter, the range may be influenced by the quality of print the user desires.

If the first resolution does not correlate with the optimum resolution, the document is rescanned at the optimum resolution. In an exemplary embodiment, the completion amount of the scanner is determined 500. If the completion is less than a predetermined threshold (in one exemplary embodiment 50%), the scanner will return to its original starting position and rescan the document in first direction 600. However, if the completion is greater than or equal to the predetermined threshold, the scanner will rescan the document in a second, different direction 700. As seen in FIG. 1, the critical completion amount 70 is between the first end of the scanner 50 and the second end of the scanner 80. While the predetermined threshold of 50% is an exemplary embodiment, other completion amounts may be utilized to adjust for the individual scanner characteristics. In another embodiment, a user can vary the predetermined threshold through one or more user selections.

Typically, the scanner aborts the scan and continues to the other end of the document so the document can be scanned in the reverse direction. This reduces the distance the scanner must travel before rescanning at the optimum resolution. Depending on the actual scanner, the target completion percentage may change. For instance, it may be more efficient to scan in a second direction even at a completion percentage lower than the predetermined threshold to avoid stopping and reversing the scanner on its first pass. Some scanners may also scan in a different direction other than reverse. For example, the first resolution scan may be from top to bottom and the optimum resolution scan may be from left to right.

Once the document is scanned at the optimum resolution, or the first resolution if the first resolution correlates to the optimum resolution, a copy of the document is printed using the print settings 800. In one exemplary embodiment, the printing process initiates before the scan completes to decrease the overall time between scanning and printing. Once the print settings are known, the printer can prepare accordingly without waiting for the final scan to complete. The printer may also start printing the copy while the scan bar is still completing its final pass.

The exemplary embodiment in FIG. 1 and FIG. 2, as well as other embodiments that maintain the spirit of the invention, may be incorporated into an all-in-one printer. All-in-one printers are scanners and printers that are combined into a single device. The device may also have further functions or technology incorporated thereon.

In yet another exemplary embodiment, the invention is a computer readable medium having a computer program embodied thereon, the computer program being executable by a machine to scan a document and print a copy. The machine executes the acts of scanning the document with a first resolution, determining a content type of the scanned document while scanning at the first resolution and determining an optimum scanning resolution based on the content type. The machine further executes the acts of rescanning the document at the optimum resolution if the first resolution does not correlate with the optimum resolution, selecting a print setting based on the content type and printing the copy using the print setting.

The foregoing description of several methods and embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for scanning a document and printing a copy, the method comprising:
scanning the document with a first resolution;
determining a content type of the scanned document while scanning at the first resolution;
determining an optimum scanning resolution based on the content type;
if the first resolution does not correlate with the optimum resolution, rescanning the document at the optimum resolution;
selecting a print setting based on the content type; and
printing the copy using the print setting.

2. The method of claim 1, wherein the first resolution is a nominal resolution.

3. The method of claim 2, wherein the nominal resolution is 300 dpi.

4. The method of claim 1, wherein the act of scanning the document with a first resolution comprises scanning only a portion of the document.

5. The method of claim 4, wherein if the first resolution corresponds with the optimum scanning resolution, scanning a remainder of the document at the first resolution.

6. The method of claim 1, wherein determining the content type further comprises determining a whether the document is one of black/white, grayscale, color, and combination of at least two of the foregoing.

7. The method of claim 1, wherein determining the content type further comprises determining a color gamut of the scanned document.

8. The method of claim 1, wherein rescanning the document at the optimum resolution comprises:
determining a completion amount of the first resolution scanning, wherein the first resolution scanning is performed in a first direction;
if the completion amount of the first resolution scanning is less than a predetermined threshold, then rescanning the document in the first direction; and
if the completion amount of the first resolution scanning is more than or equal to the predetermined threshold, then rescanning the document in a second direction.

9. The method of claim 8, wherein the second direction is reverse of the first direction.

10. The method of claim 8, wherein the act of printing a copy initiates before the act of rescanning the document completes.

11. A computer readable medium having a computer program embodied thereon, the computer program being executable by a machine to scan a document and print a copy comprising the acts of:
scanning the document with a first resolution;
determining a content type of the scanned document while scanning at the first resolution;
determining an optimum scanning resolution based on the content type;
if the first resolution does not correlate with the optimum resolution, rescanning the document at the optimum resolution;
selecting a print setting based on the content type; and
printing the copy using the print setting.

12. The computer readable medium for claim 11 wherein the act of scanning the document with a first resolution comprises scanning only a portion of the document

13. The computer readable medium for claim 11 wherein the first resolution is a nominal resolution.

14. The computer readable medium for claim 11 wherein the act of rescanning the document at the optimum resolution further comprises:
determining a completion amount of the first resolution scanning, wherein the first resolution scanning is performed in a first direction;
if the completion amount of the first resolution scanning is less than a predetermined threshold, then rescanning the document in the first direction; and
if the completion amount of the first resolution scanning is more than or equal to the predetermined threshold, then rescanning the document in a second direction.

15. The computer readable medium for claim 14 wherein the second direction is reverse of the first direction.

16. An all-in-one printer for scanning a document and printing a copy comprising:
a scanner adapted to scan a portion of the document at a first resolution,
the scanner further adapted to determine a content type of the document based on the scanned portion of the document, determine an optimum scanning resolution based on the content type and create an image by either continue scanning a remainder of the document if the first resolution is similar to the optimum resolution, or, rescan the document with the optimum resolution if the first resolution is not similar to the optimum resolution; and
a printer adapted to print a copy of the image using a print setting based on the content type.

17. The all-in-one printer of claim 16, wherein determining the content type further comprises determining a color gamut of the scanned document.

18. The all-in-one printer of claim 16 wherein the first resolution is a nominal resolution.

19. The all-in-one printer of claim 16 wherein rescanning the document with the optimum resolution further comprises:
determining a completion amount of the first resolution scanning, wherein the first resolution scanning is performed in a first direction;
if the completion amount of the first resolution scanning is less than a predetermined threshold, then rescanning the document in the first direction; and
if the completion amount of the first resolution scanning is more than or equal to the predetermined threshold, then rescanning the document in a second direction.

20. The all-in-one printer of claim 19 wherein the second direction is reverse of the first direction.
